(19) United States
(12) Patent Application Publication
(10) Pub. No.: US 2025/0058694 A1
(43) Pub. Date: Feb. 20, 2025

(54) SCREEN ROOM FOR RECREATIONAL VEHICLES

(71) Applicant: MedEd Associates, Inc., Williamston, MI (US)

(72) Inventors: Scott A. Clarke, Williamston, MI (US); Sheri L. Clarke, Williamston, MI (US)

(21) Appl. No.: 18/808,426

(22) Filed: Aug. 19, 2024

Related U.S. Application Data
(60) Provisional application No. 63/533,603, filed on Aug. 18, 2023.

(51) Int. Cl. B60P 3/34

(52) U.S. Cl. CPC B60P 3/341

(57) ABSTRACT

A screen room for a recreational vehicle (RV) substantially precludes insects from accessing a porch that is temporarily set up using a loading ramp of the RV as a porch floor, and provides weather protection for occupants of the loading ramp and the RV, thereby effectively converting the loading ramp into a temporary elevated screened porch. The screen room is made highly resistant to infiltration by insects by way of corner flaps that wrap around ramp supports and then couple to frame portions that define the opening of the RV when the ramp is lowered, as well as gap-filling panels that can be placed and temporarily secured to the ramp or the ramp opening's frame.

### CROSS REFERENCE TO RELATED APPLICATION

The present application claims the benefit of U.S. provisional application Ser. No. 63/533,603 filed Aug. 18, 2023, which is hereby incorporated herein by reference in its entirety.

### FIELD

The present disclosure relates to enclosure accessories for cargo trailers, recreational vehicles (“RV's”), camper-trailers, and similar vehicles having drop-down loading ramps.

### BACKGROUND

Recreational vehicles (“RV's”) including “toy haulers,” as well as cargo trailers and some camper-trailers are often equipped with drop-down ramps that facilitate loading of cargo. In the case of toy haulers, the cargo typically includes one or more smaller motorized vehicles such as an all-terrain vehicle (“ATV”) or a side-by-side vehicle or utility task vehicle (“UTV”), motorcycles, dune buggies, race cars, snowmobiles, or the like. Oftentimes the RV or trailer is also outfitted for use as a camper, including sleeping areas, seating areas, bathroom, and cooking facilities, generally located forwardly of the loading ramp. The loading ramp is often supported by cables that may be spring-loaded to aid in lifting and lowering the ramp by hand, although power-actuated loading ramps may also be provided. For loading purposes the ramp is pivotally connected at or adjacent a floor surface of the RV or trailer, and its opposite end can be lowered into contact with a ground surface below the floor surface and behind the RV or trailer.

Some loading ramps are adequately supported (such as with cables, linkages, or ground-contacting supports such as extendable legs or jack stands) so that they can be used in a horizontally-extended orientation in which the ramp's distal end is supported above the ground surface to provide a standing or seating area (i.e., an elevated porch) that is outside of the enclosed portions of the RV or trailer, but still elevated above the ground surface, and readily accessible from the floor surface of the RV or trailer. Because a loading ramp in this position exposes the ramp to weather and other environmental factors like insects, while also leaving the interior of the RV or trailer open to insects, a tent-like screened enclosure may be provided to provide some degree of protection for occupants and the RV's or trailer's interior from sun, rain, wind, and insects. Although desired levels of sun, rain, and wind protection may be achieved with choice of materials and selection between screened panels and waterproof or water-resistant panels, it can be particularly difficult to prevent insects from entering, since insects are often adept and finding small gaps and passageways between surfaces.

### SUMMARY

The present disclosure provides an insect-resistant screen room for attachment to an opening formed by a partially-lowered ramp or panel of an RV or trailer or other structure, to convert the ramp or panel into a screened porch. The screen-room includes fabric and screen mesh panels supported by a framework that is similar to camping tent structures, but with a set of forward-end fabric panels, tabs, and magnets that facilitate a weather-resistant and insect-resistant room-to-RV interface, which is easy to set up without need for tools. Overlapping fabric panels allow support cables and other structures, which could otherwise create ingress passageways for insects, to be enveloped and effectively sealed off from insects, while the use of magnets as releasable couplers facilitates rapid attachment and detachment, as well as allowing for attachment of a given fabric panel utilizing a magnetic fields that pass through another fabric panel. The take-down procedure is simple, relying easy detachment of magnets by gentle pulling on their associated fabric panels or tabs, followed by removal of the still-erected screen room and then breaking down the framework in a conventional manner.

In one form, a screen room for a recreational vehicle (RV) or structure wall includes a lateral upper panel with an upper panel flap at each opposing end, and left and right side panels that couple to and extend downwardly from the opposing ends of the upper panel flap, the side panels each having a side panel flap at an upper end region thereof. Each of the upper panel flaps has a pair of upper panel flap couplers that are spaced apart from one another, and each of the side panel flaps has a side panel flap coupler. Optionally, these couplers are magnets. The side panel flap couplers are releasably securable to a frame that defines portions of a ramp or panel opening of the RV or structure wall. First upper panel flap couplers are releasably securable to the frame, near the side panel flap couplers, with respective ramp support cables received between the upper panel flaps and corresponding side panel flaps. The second upper panel flap couplers can extend laterally inboard and forwardly of the support cables, and are releasably securable to the frame. The upper panel flaps are configured to extend across respective upper corner gaps that are defined between the upper panel and the frame. The side panel flaps extend across respective side gaps defined between the side panels and the upper frame.

This arrangement of upper panel, side panels, flaps, and releasable fasteners facilitates a releasable coupling interface for the screen room to the opening of an RV or structure wall that is fitted with a lowerable and raisable ramp or similar panel structure. A roof panel, sidewall panels, and rear panel, all typically supported by a framework, are attached to the upper panel and side panels to enclose a volume of space above the ramp and outboard of the opening in the RV or structure wall when the ramp is lowered. Those panels may be a combination of fabrics, screen mesh materials, translucent or transparent polymeric sheets, and the like, to provide desired levels and regions of weather-resistance and ventilation. The ability to fill gaps between the RV or structure wall and the roof panel and sidewall panels, with the upper panel and side panels and their associated flaps, as well as the ability to wrap or otherwise enclose the ramp support cables with portions of the flaps, enables the resulting enclosure to substantially block insects of all sizes from accessing the interior space.

The resulting screen room can be substantially erected atop or near the ramp or panel and then its forward end, which is formed by the upper panel and side panels, can be quickly and releasably secured to the RV or structure wall in a manner that substantially precludes ingress by insects, which may be attracted by food odors, light, and other attractants. Because the support cables associated with lowerable ramps or platforms can otherwise provide locations for easy access by insects walking along the cables, wrapping or otherwise enclosing the upper ends of those cables with panel flaps can further reduce the ability of insects to access the interior space of the screen room.

These and other objects, advantages, purposes and features of the present concepts will become apparent upon review of the following specification in conjunction with the drawings.

### BRIEF DESCRIPTION OF THE DRAWINGS

FIG. 1 is an exterior right side perspective view of a screen room shown attached to a ramp that extends horizontally from a rear of a trailer or RV;

FIG. 2 is an exterior left-rear perspective view of the screen room, ramp, and trailer or RV of FIG. 1;

FIG. 3 is an exterior right-rear perspective view of a forward portion of the screen room shown attached to the ramp and rear portion of the trailer or RV;

FIG. 4 is a another exterior right-rear perspective view of a forward portion of the screen room shown attached to the ramp and rear portion of the trailer or RV, with hidden structures depicted in phantom lines;

FIG. 5 is an interior perspective view of a rear portion of the screen room and the ramp, looking rearwardly from the trailer or RV;

FIG. 6 is another interior perspective view of a right side region of the screen room and the ramp, looking rearwardly and toward the right from a position near the forward portion of the ramp at the rear ramp opening of the RV;

FIG. 7 is an exploded plan view of the forward side panels and forward upper panel of the screen room, which panels interface with the rear portion of the trailer or RV;

FIG. 8 is an assembled plan view of the forward side panels and forward upper panel of the screen room, viewed from an interior side;

FIG. 9 is an exterior perspective view, looking rearwardly, of an upper-left forward corner region of the screen room showing an upper region of the forward-left side panel and its side panel flap, in which the side panel flap is obscuring a left end portion of the forward upper panel and upper panel flap from view;

FIG. 10 is another exterior perspective view, looking rearwardly, of the upper-left forward corner region of the screen room, showing a left side region of the upper panel and the upper panel flap, in which the side panel flap is pulled upwardly and laterally, and partially out of view, to expose the full upper panel flap;

FIG. 11 is an interior perspective view of the upper-left forward corner region of the screen room, showing the left side panel flap substantially unfolded and held against an opening frame of the trailer or RV at the opening that is exposed by the open ramp, and with a framework of the screen room spaced rearwardly from the opening frame of the trailer or RV;

FIG. 12 is another interior perspective view of the upper-left forward corner region of the screen room, showing the upper panel flap hanging substantially freely and downwardly from the left side region of the upper panel;

FIGS. 13A-13L are a series of interior perspective views of the upper-left forward corner region of the screen room, showing a sequence of installation steps for the upper panel flap after the left side panel flap has been placed as shown in FIG. 11;

FIG. 14 is a photograph that substantially corresponds to FIG. 13K, showing the upper panel flap and left side panel flap in their installed configurations;

FIG. 15 is an exterior perspective view of the upper-right forward corner region of the screen room, showing a portion of the right side panel flap extending rearwardly from the upper-right corner region of the opening frame of the trailer or RV, and with the upper panel not secured so that a gap remains between the upper framework of the screen room and the upper opening frame of the trailer or RV;

FIG. 16 is another exterior perspective view of the upper-right forward corner region of the screen room, generally corresponding to FIG. 15, and showing the upper panel secured to close the gap between the upper framework of the screen room and the upper opening frame of the trailer or RV;

FIG. 17 is an interior perspective view of a middle region of the right forward side panel, showing a magnetic tab extending forwardly along an inboard surface of the right side opening frame of the trailer or RV;

FIG. 18 is another interior perspective view of a middle region of the right forward side panel, showing the magnetic tab pulled forwardly and wrapped around a forward edge of the right side opening frame of the trailer or RV, with a magnetic portion of the magnet tab obscured from view while positioned along an outboard surface of the right side opening frame of the trailer or RV; and

FIG. 19 is an interior perspective view of a middle region of the forward left side panel of the screen room, showing size-adaptable dimensions that facilitate adaptation of the screen room to different sizes of ramps and openings to the interiors of trailers or RV's.

### DESCRIPTION OF THE PREFERRED EMBODIMENTS

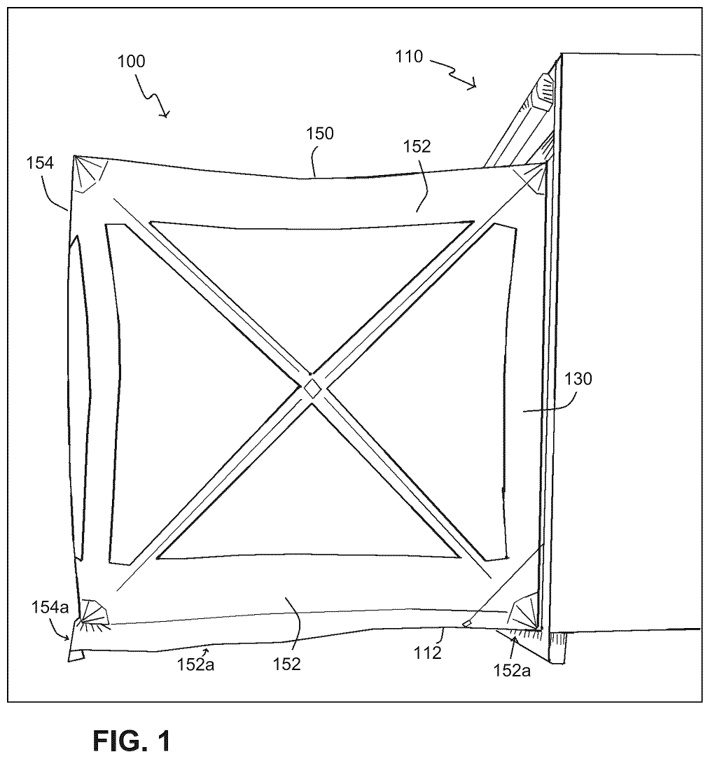

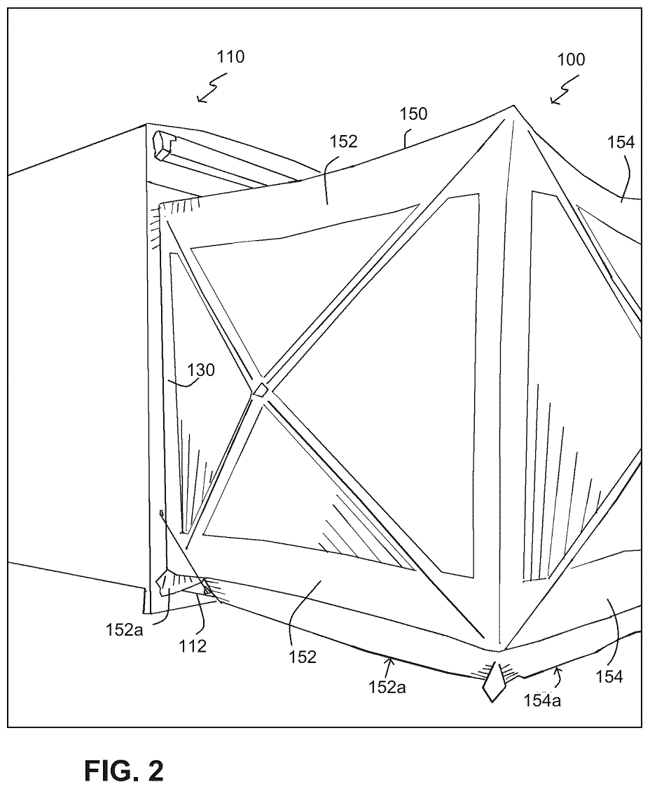

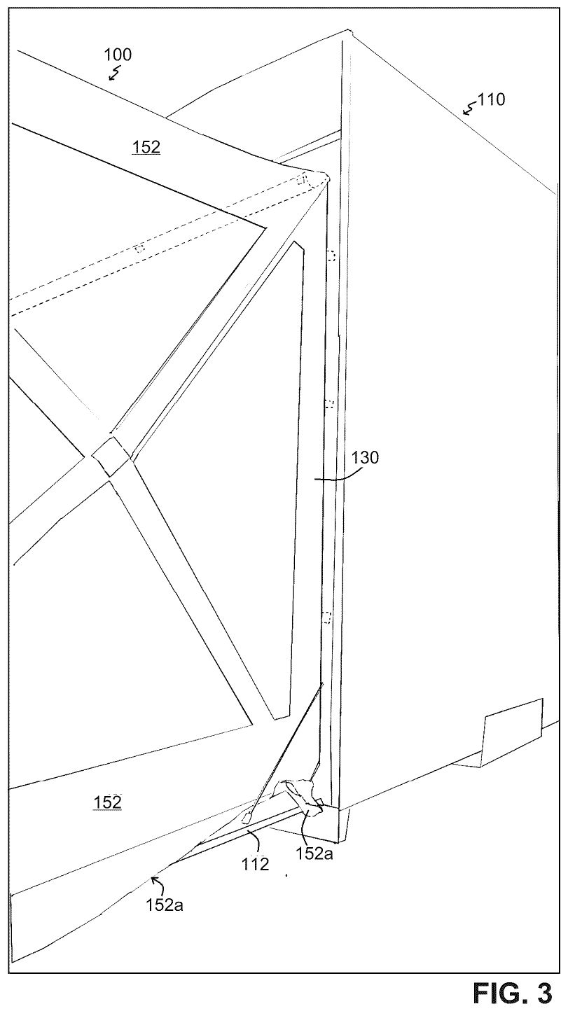

Referring now to the drawings and the illustrative embodiments depicted therein, a screen room 100 is provided for a recreational vehicle (“RV”) 110 having a loading ramp 112, such as shown in FIGS. 1-6. Screen room 100 allows users of the RV to temporarily enclose the loading ramp 112 with weather-resistant and insect-resistant fabric and screen materials, so that the ramp 112 may be positioned in a generally horizontal orientation and used as a screened porch. It will be appreciated that a “generally horizontal orientation” in this context is one that allows persons to comfortably stand or sit, without excessive leaning or lateral loads caused by the tilt angle, if any. The interior of the RV remains readily accessible from the ramp 112, allowing for a large volume of airflow through the ramp opening 114 at the rear of the RV while limiting or preventing the ingress of insects to the RV's interior. By providing a series of strategically-placed magnetic closures or other releasable fasteners, along with strategically-shaped panels and panel flaps at the front of the screen room 100 where it meets the RV 110, the various gaps and entry points may be substantially closed off, while remaining simple to set up or take down as desired, optionally without need for tools. The screen room 100 is also adaptable for use with a range of sizes of ramps 112 and ramp openings 114, so that an appropriate fit to different RVs can be achieved by a single screen room.

Although the screen room is well-suited for use with so-called “toy hauler” trailers with living quarters in front, vehicle storage at the rear, and a rear loading ramp for moving smaller vehicles into and out of the vehicle storage area, it is envisioned that the screen room may be used in other applications. Therefore, it should be appreciated that throughout this application, the abbreviated term “RV” will be used to refer to substantially any recreational vehicle that includes a ramp with supports that allow the ramp to be positioned and maintained at a substantially horizontal orientation that is suitable for comfortable standing or sitting. Such recreational vehicles include, but are not necessarily limited to, camper trailers, self-powered camper vehicles, cargo trailers, horse trailers, and even boats. It is further envisioned that the screen room could be used with a deployable ramp or wall panel that forms an exterior wall panel of a stationary building, which ramp or wall panel can be deployed outwardly from the building to form a temporary porch.

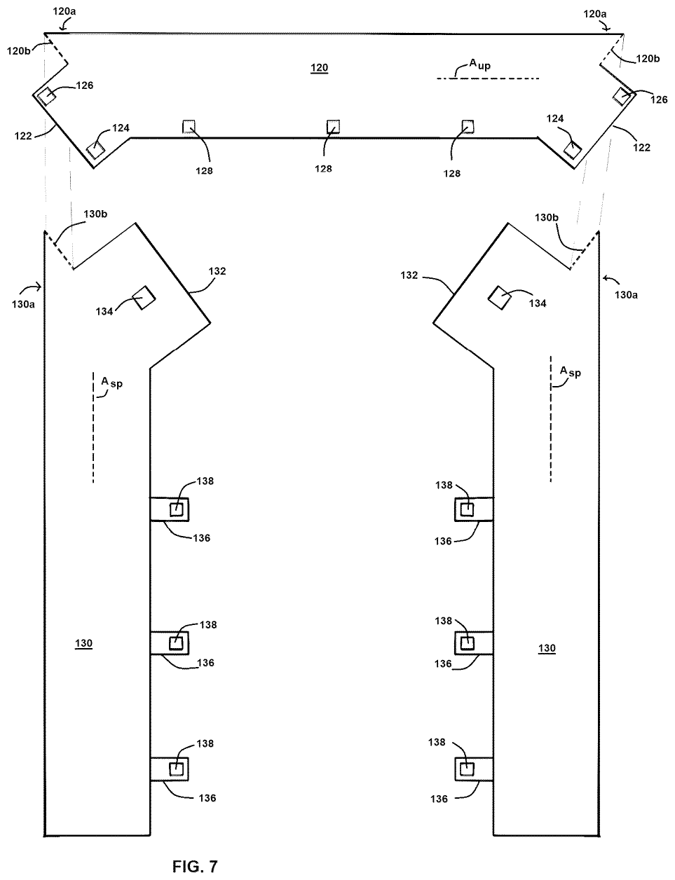

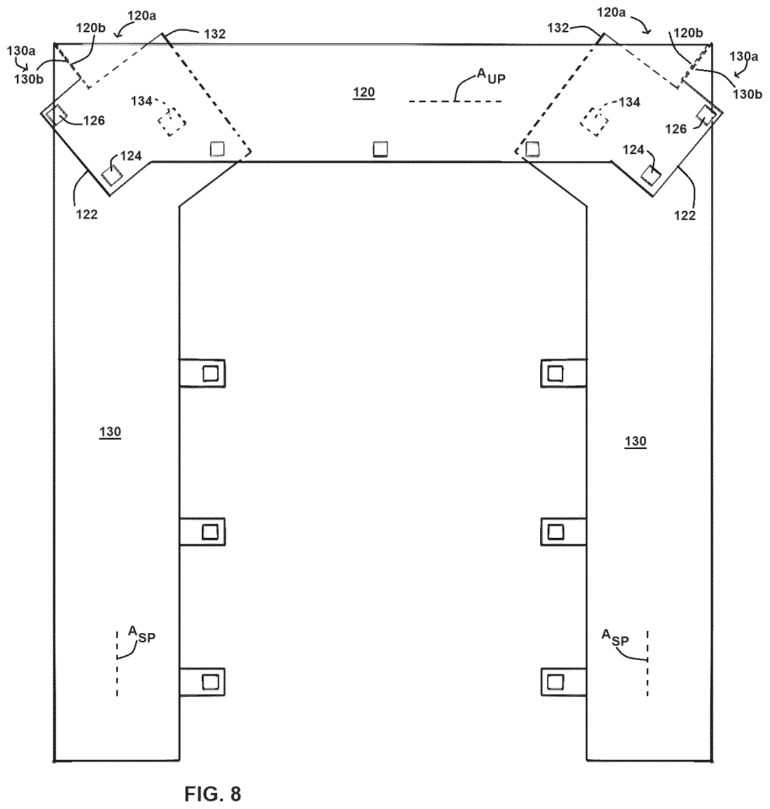

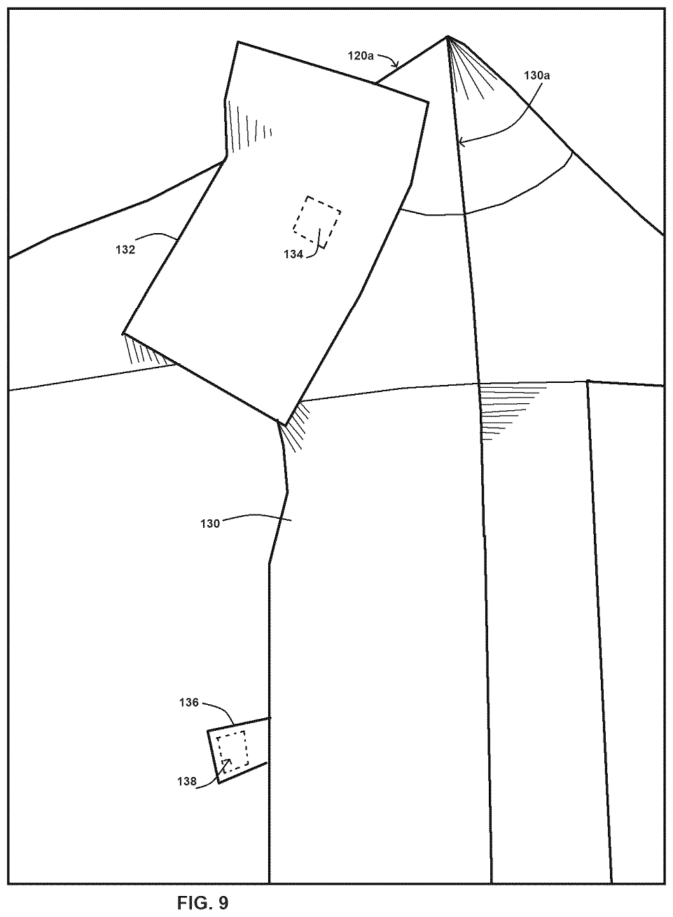

Referring now to FIGS. 7-10, various panels of screen room 100 includes a forward upper panel 120 that extends across a width of the screen room at a forward end thereof, with forward side panels 130 arranged in a mirror image to one another. Forward side panels 130 have upper end portions 130a that couple to opposite left and right end portions 120a of the upper panel 120 as shown in FIG. 7, with side panels 130 extending downwardly from the upper panel 120 when installed, such as shown in FIGS. 1-4, 9, and 10. At each of the end portions 120a, 130a there is a respective diagonal edge 120b, 130b, with those diagonal edges being sewn together as shown in FIG. 8. Spaced diagonally below and inboard of the upper corners formed by diagonal edges 120b, 130b are a pair of upper panel flaps 122 (one at each end portion 120a) and a side panel flap 132 at the upper end portion 130a of each side panel 130. In the illustrated embodiment, each panel flap 122, 132 is generally rectangular in shape and arranged on a diagonal relative to the longitudinal axis A_{UP} of the upper panel 120 and the longitudinal axes Asp of the side panels 130 (FIGS. 7 and 8). The upper panel flaps 122 extend diagonally in a downward and laterally outboard direction, while the side panel flaps 132 extend diagonally in an upward and diagonally inboard direction, as best shown in FIGS. 7-10. Because the side panels 130 are secured to the upper panel 120 only at the upper corners where edges 120b, 130b meet, other structures may pass between the end portions 120a of the upper panel 120 and the respective upper end portions 130a of the side panels 130, in the area of upper panel flaps 122 and side panel flaps 132 (FIG. 8).

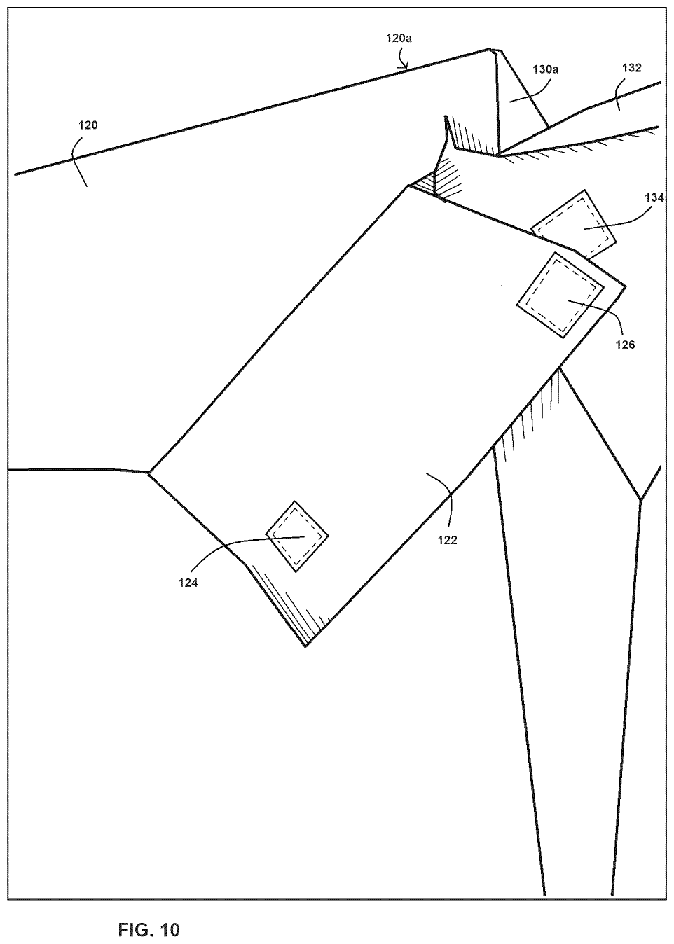

With continued reference to FIG. 7, each side panel flap 132 includes a releasable fastener or coupler in the form of a centrally-located magnet 134, and each upper panel flap 122 includes a pair of releasable fasteners or couplers in the form of an inboard magnet 124 and an outboard magnet 126. In FIGS. 7 and 8, the inboard magnet 124 and outboard magnet 126 are shown positioned similarly to one another, in respective outer corners of each upper panel flap 122. However, in later figures (specifically, FIGS. 10, 12, 13E, and 13G) it can be seen that inboard magnets 124 are further offset from their respective corners of their upper panel flaps 122, as compared to the outboard magnets 126 relative to their respective corners. The placement of each magnet 124, 126, 134 can be varied as desired for a given application, and in fact the placement can typically be varied to a significant extent without adversely affecting performance. In addition to the side panel flap magnets 134, each side panel 130 includes a series of vertically-spaced and inboard-extending tabs 136 that each has its own magnet 138 for securing to a side jamb 140a of door frame or ramp opening frame 140, as will be described below. Along the lower edge of upper panel 120 is a series of horizontally-spaced magnets 128 for securing to a header 140b of the ramp opening frame 140.

The magnets 124, 126, 128, 134, 138 are typically sewn into pouches formed from an additional section of fabric for each magnet, although it will be appreciated that magnets may be attached with adhesives, hook-and-loop fasteners, clips, or other mechanical fasteners. Magnets 124, 126, 134 are readily attachable to (and releasable from) ferrous metal, which is typically used to form the door frame or ramp opening frame 140 that surrounds at least the sides and upper (header) portion of the ramp opening 114. Magnets can be attached to ferrous metal even with intervening sheets of material, such as fabric, which is also advantageous for this application as will be more fully appreciated with the descriptions that follow. Magnets also facilitate adjustment and repositioning of fabric panels and tabs because they can be readily slid along the frame 140 in order to remove wrinkles and achieve proper alignment of the screen room 100 relative to the frame 140. Magnets have an additional advantage in being slidable along the surfaces to which they are magnetically attached, which can reduce peak tensile loads in the fabrics (such as during windy conditions) by allowing certain magnets to slide laterally when sufficient tension builds in the fabrics, rather than holding fast. However, other types of releasable fasteners are envisioned, such as hook-and-loop fasteners, snap buttons, and the like. While these other types of releasable fasteners are not necessarily as easy to reposition as magnets along a ferrous metal frame, and cannot be readily secured through intervening fabric layers like magnets can, they have some of their own advantages such as being usable along non-ferrous surfaces such as aluminum, wood, fiberglass, and resinous plastic. It will be appreciated that the type of releasable fastener selected for a given application will depend on such factors as the material(s) of the RV surrounding the ramp opening 114, material cost, labor cost, and other factors such as the holding force desired for a given application.

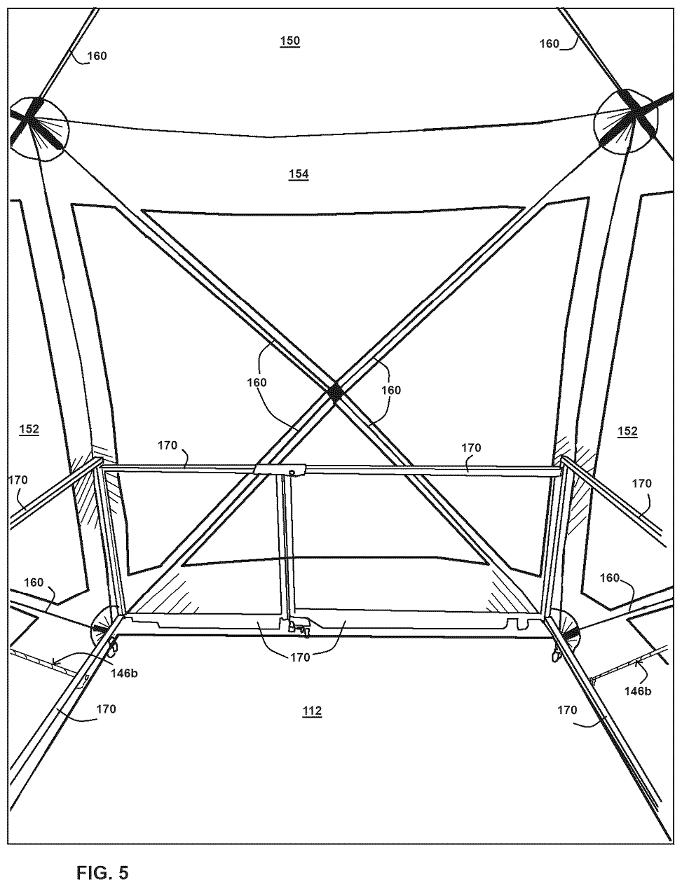

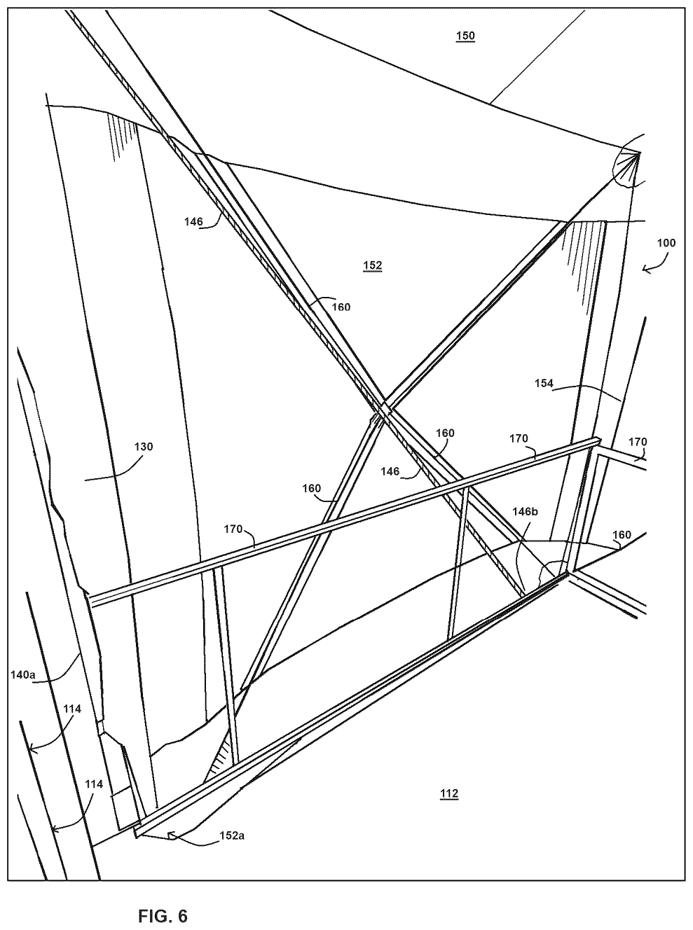

It should be appreciated that forward upper panel 120 and forward side panels 130 merely form a forward RV-interfacing region of screen room 100, and that the remainder of screen room 100 is constructed from a series of flexible sheet panels made of desired combinations of weather-resistant fabric and/or polymeric sheet materials, and screen mesh, supported by a collapsible or readily-disassembled framework. Referring to FIGS. 1-6, the flexible sheet panels include a roof panel 150 that is coupled to and extends rearwardly from a rearward edge of the upper panel 120, left and right lateral side panels 152 that have upper edges coupled to left and right side edges of roof panel 150 and forward edges that couple to respective rearward or outboard edges of the forward side panels 130, and a back panel 154 having an upper edge coupled to a rear edge of roof panel 150 and left and right side edges coupled to respective rear edges of the lateral side panels 152. The various panels 120, 130, 150, 152, 154 are supported internally by a framework 160 (FIGS. 5 and 6) that includes a series of elongate poles or shafts whose ends are received in respective pockets formed along the interior surfaces of the panels. This form of construction is common for camping tents and similar structures, and will be readily understood with reference to those technologies.

Referring again to FIGS. 1-4, lateral side panels 152 and back panel 154 have respective lower portions 152a, 154a that are sufficiently long to extend below loading ramp 112, and may be draped around the outer periphery of the loading ramp 112 and optionally secured in place or routed through ramp structures (refer to the fabric-to-ramp interface at the lower ends of the forward side panels 130 in FIGS. 1-4 and 6) to fill or cover any gaps or openings that could otherwise be accessed by insects. The lower portions 152a, 154a also help to channel rainwater away from the loading ramp 112 to limit or prevent rainwater from flowing onto the upper surface of the loading ramp.

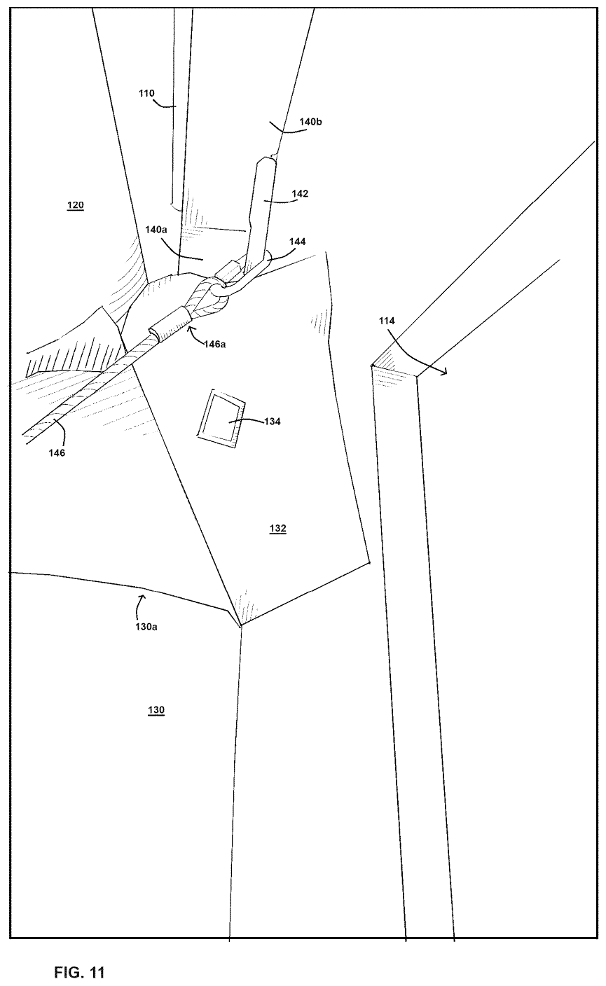

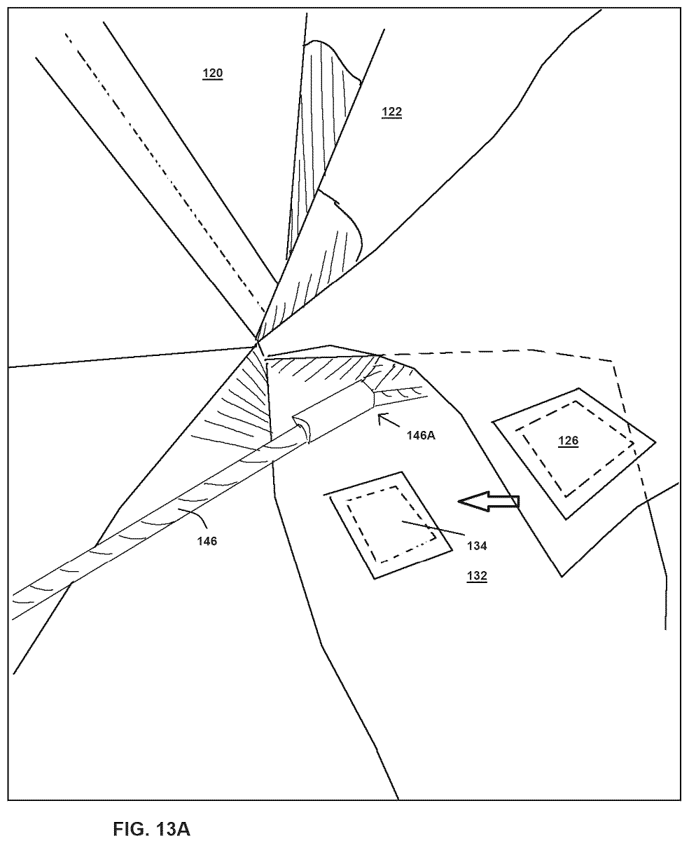

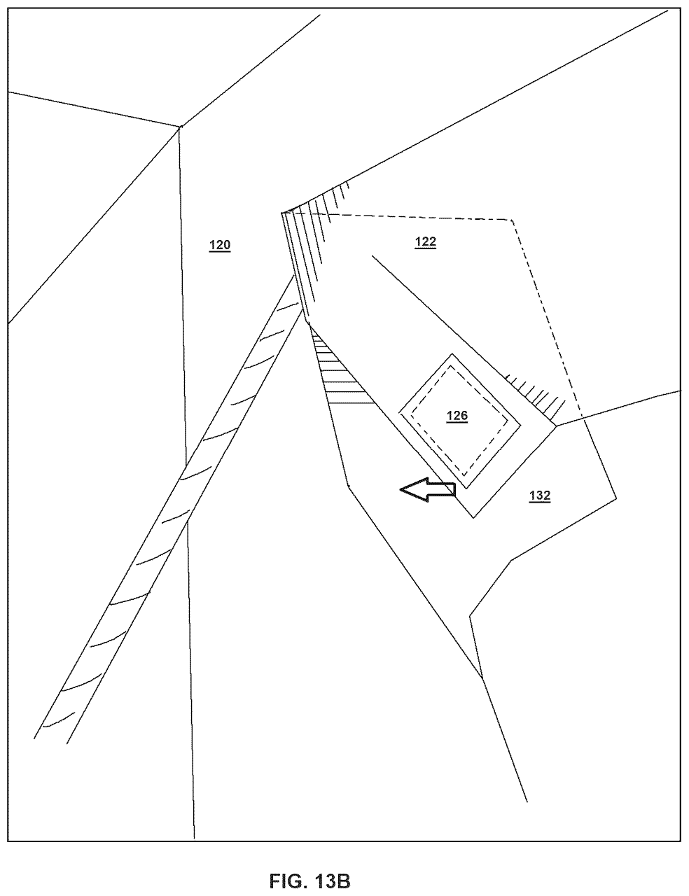

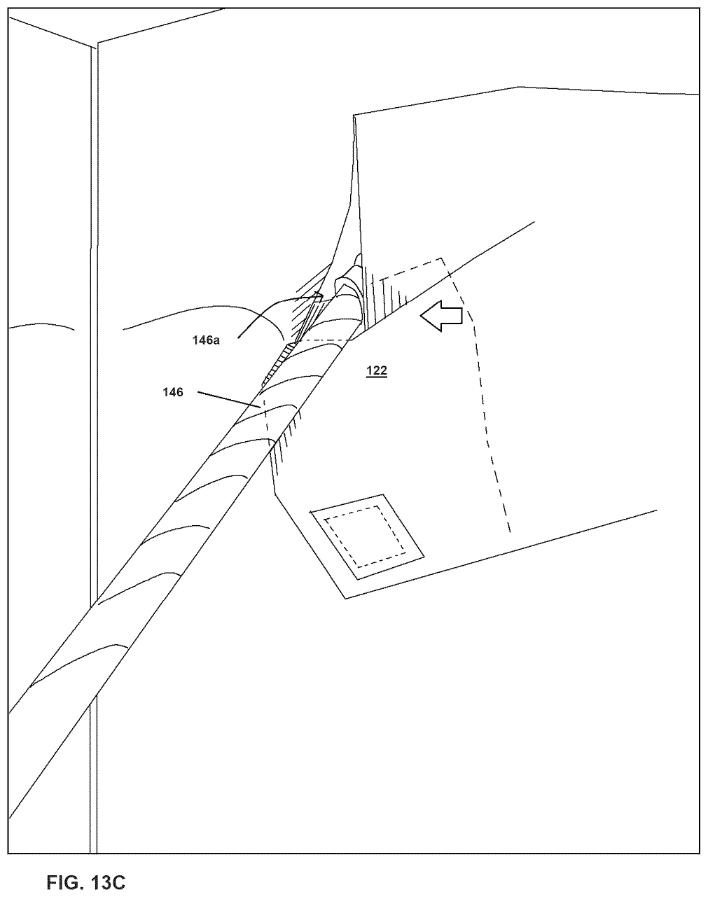

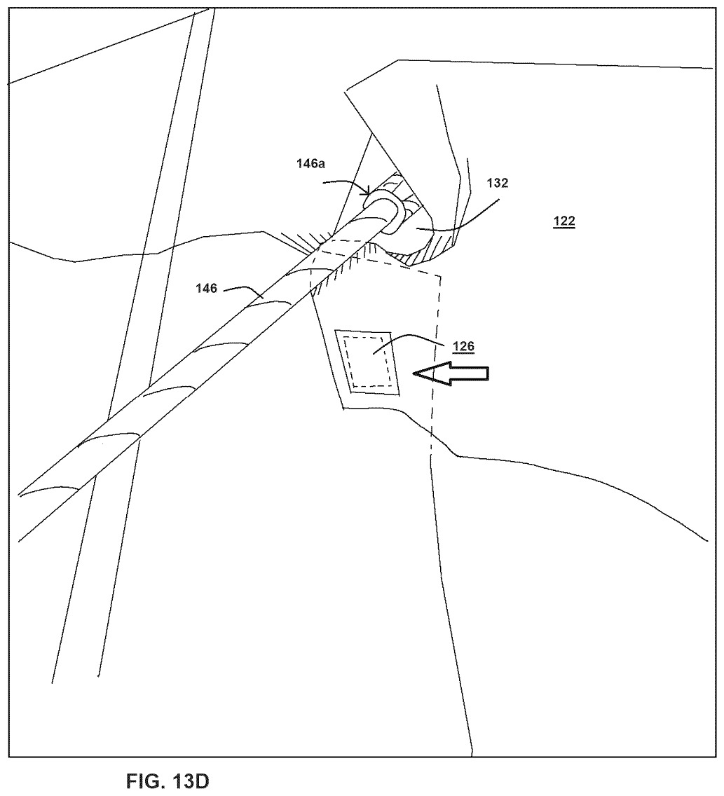

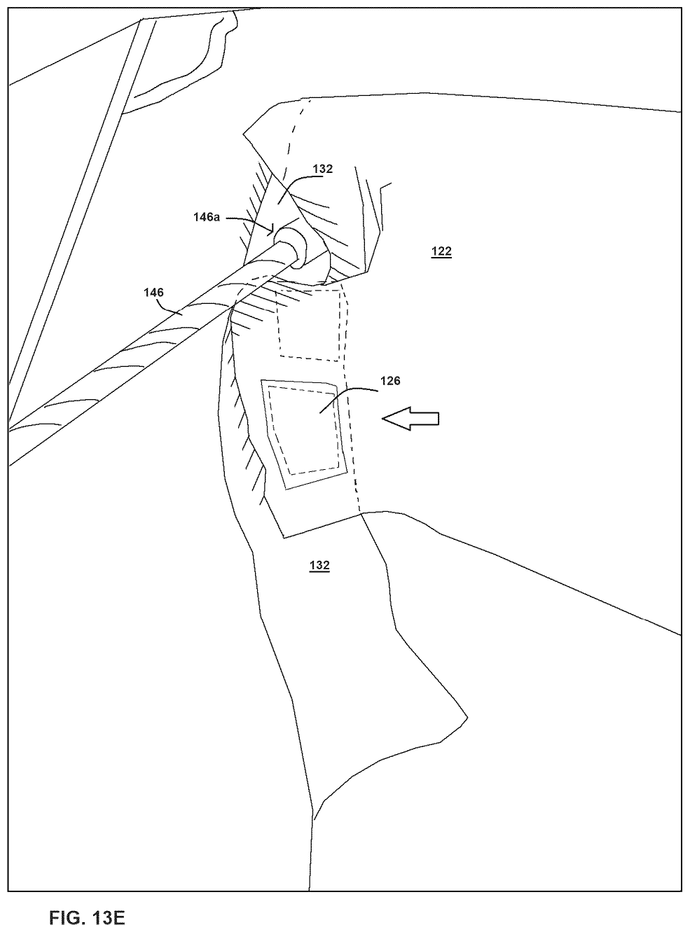

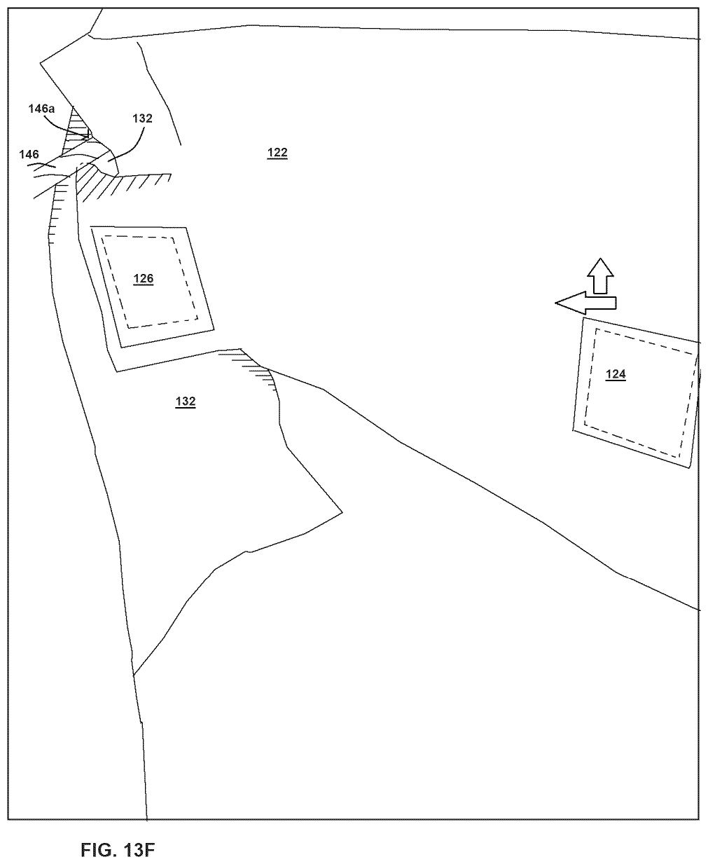

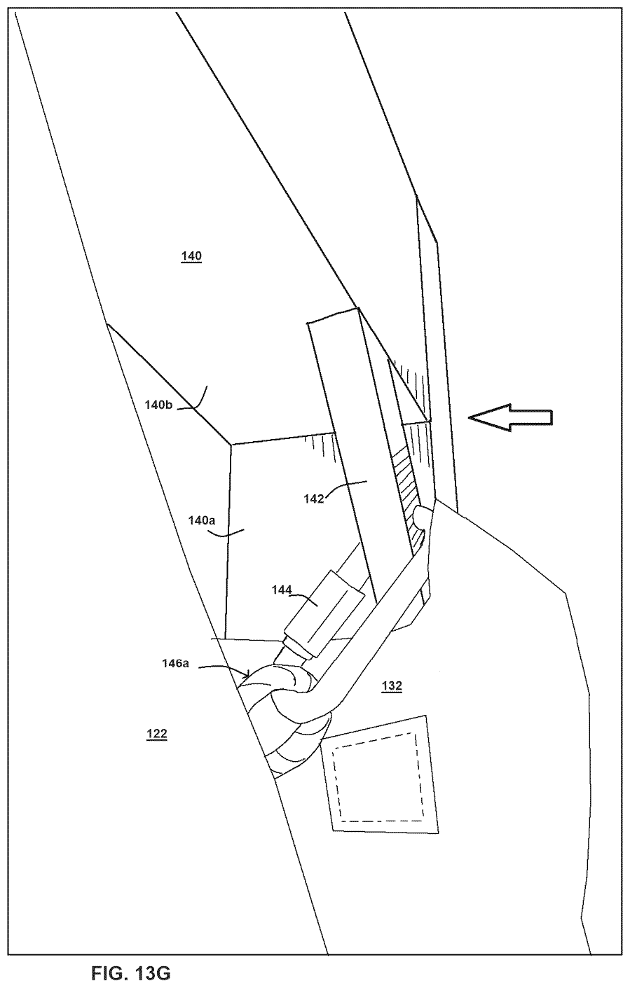

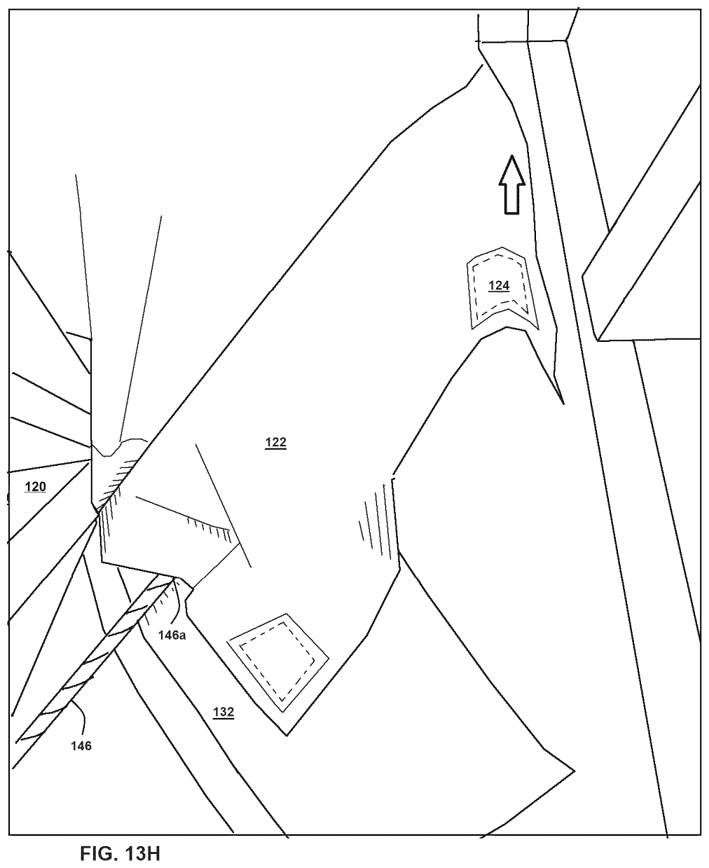

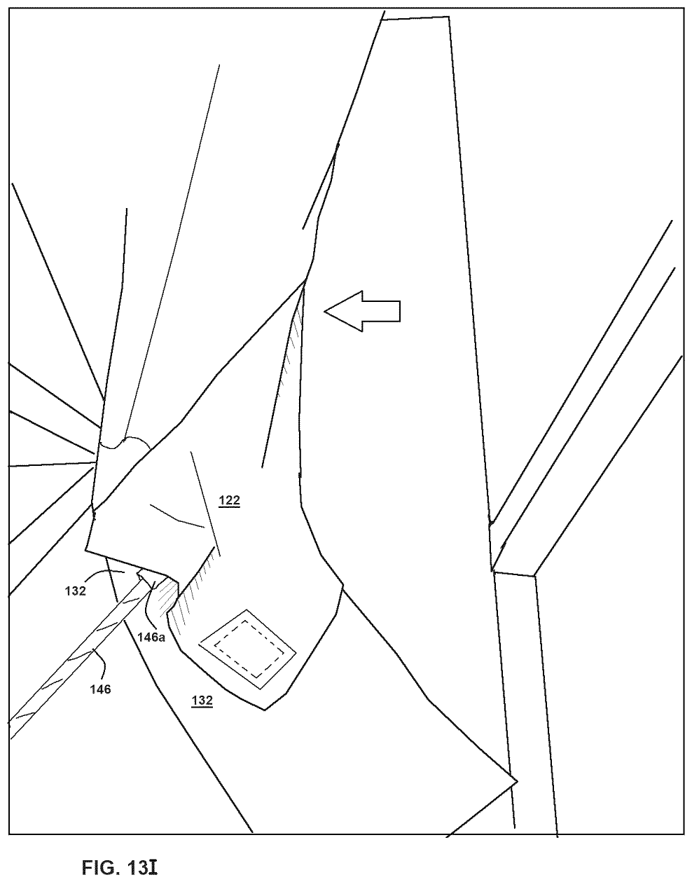

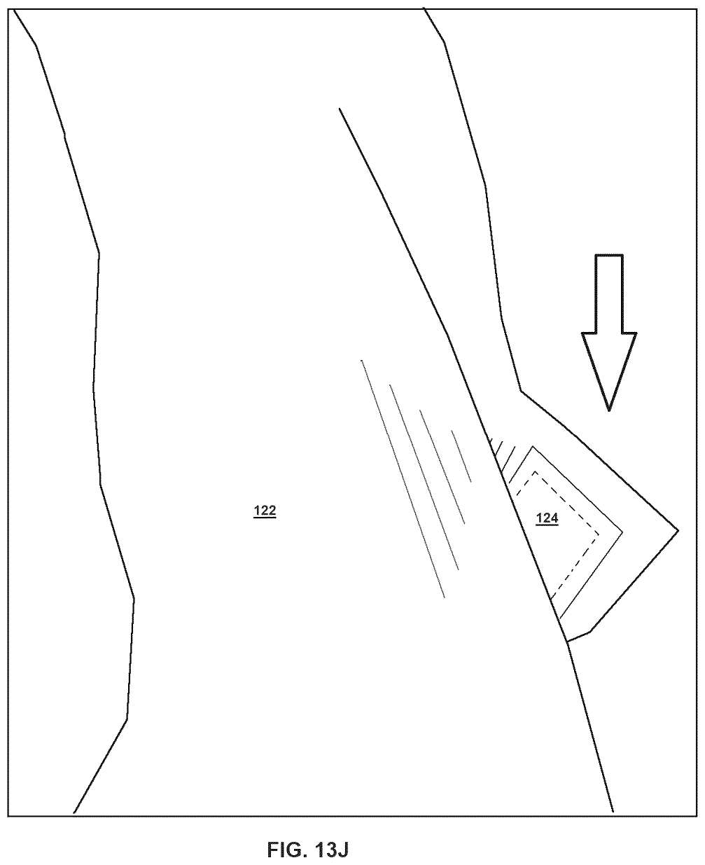

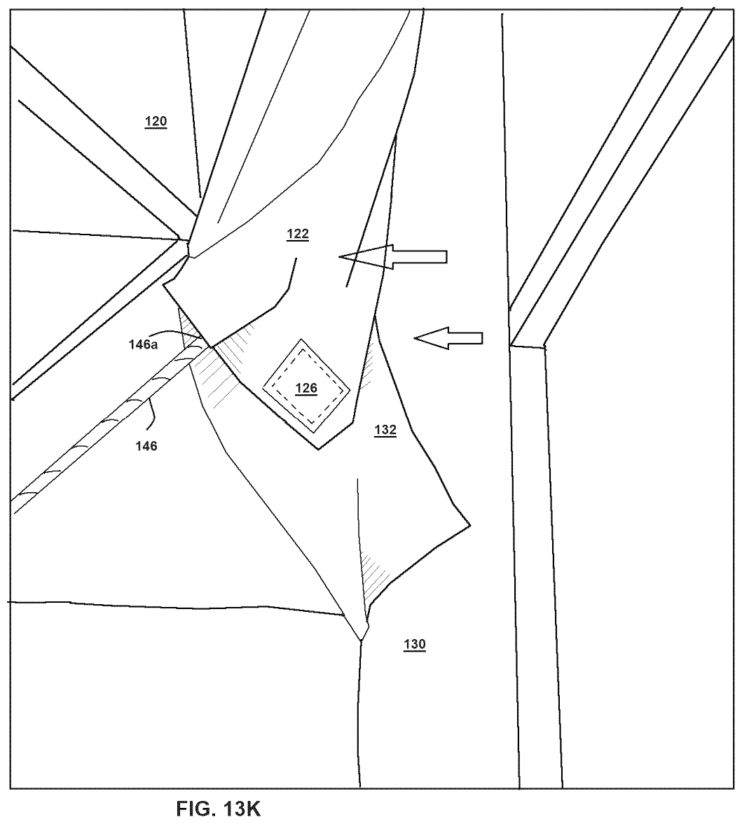

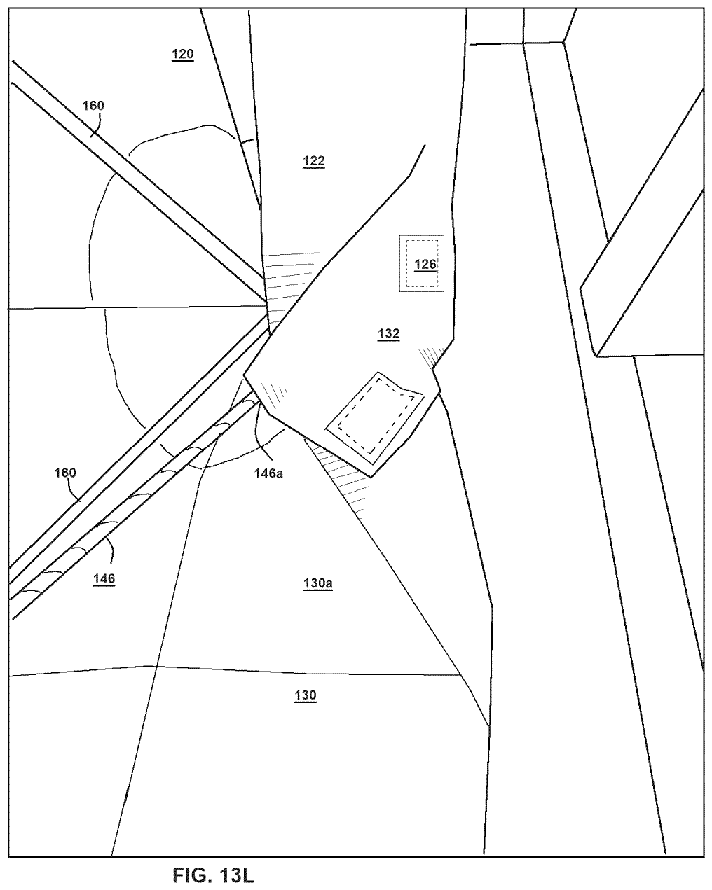

Referring now to FIGS. 13A-13L, a method of releasably securing the forward-upper corner regions of screen room 100 is illustrated sequentially with reference to the upper-left corner of the ramp opening frame 140 where the left side jamb 140a meets the left end of the frame header 140b. In the illustrated embodiment, and as also shown in FIG. 11 the frame 140 includes a corner brace 142 extending diagonally from an upper portion of the left side jamb 140a to the left end of the frame header 140b. Corner brace 142 has at least one opening that receives a cable connector 144 at the upper end portion 146a of a ramp support cable 146. The ramp support cable 146 has a lower end portion 146b that couples to a distal or rear region of the loading ramp 112, such as shown in FIGS. 5 and 6. The corner brace 142 and upper end portion 146a of ramp support cable 146 are structures that can provide ingress regions for insects, which are effectively closed off by the forward upper panel's left and right end portions 120a, the forward side panel's upper end portions 130a, the side panel flaps 122, and the upper panel flaps 132, in the manner described below with reference to FIGS. 11-13L.

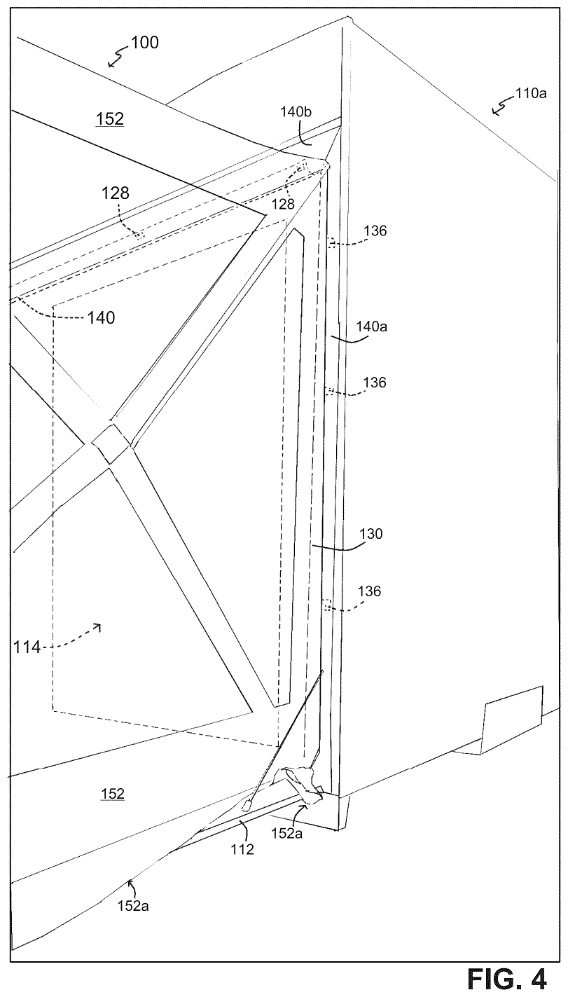

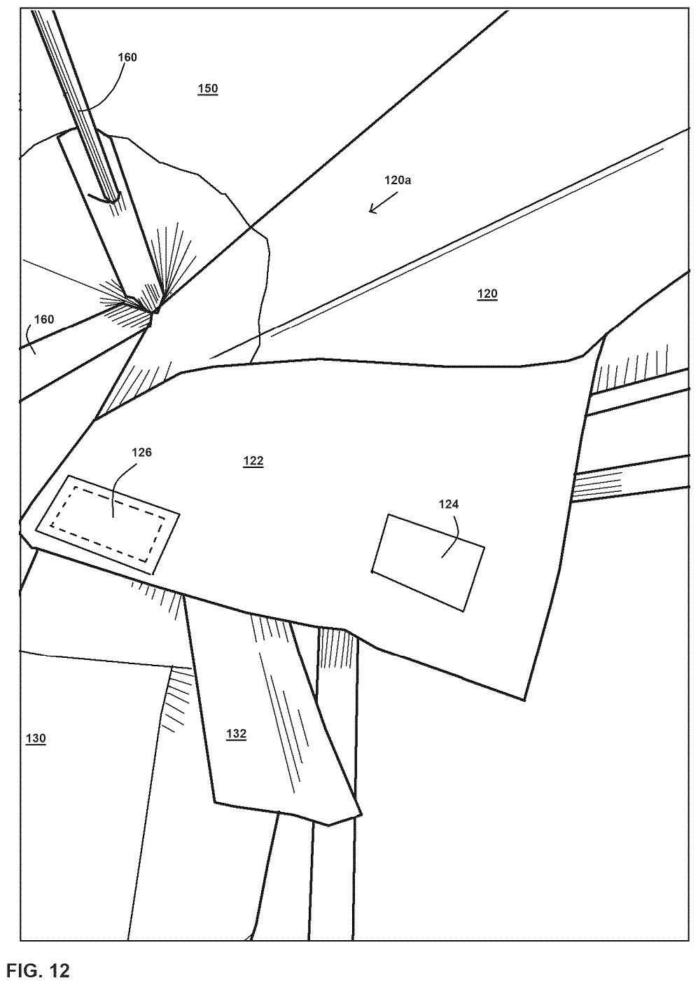

In FIG. 12 there is shown the screen room's upper-front-left corner with upper panel flap 122 hanging freely, and side panel flap 132 hanging freely behind (but directionally in front of) upper panel flap 122. A first step of enclosing this region where the screen room's upper-front-left corner interfaces with the upper-left corner of ramp opening frame 140 is to place the side panel flap 132 against the inboard-facing surface of left side jamb 140a, as shown in FIG. 11. Side panel flap magnet 134 attaches to the inboard-facing surface of left side jamb 140a so that side panel flap 132 is held in that region. Although securement of the upper panel flap 122 can be performed after the side panel flap 132 is positioned as shown in FIG. 11 it may be more convenient to first secure the horizontally-spaced upper panel magnets 128 to the forward-facing inner side of the ramp opening frame's header 140b, as shown in FIGS. 4, 15, and 16. Upper panel magnets 128 hold the upper panel 122 in place relative to the frame header 140b to span a gap that would otherwise be open between the top-forward edge of screen room 100 and the frame header 140b.

To secure the upper panel flap 122 in a manner that blocks ingress of insects in the forward upper corner regions of screen room 100, the upper panel flap's outboard magnet 126 is moved outboard and into magnetic contact with the side jamb 140a through the fabric of side panel flap 132 (see FIGS. 13A, 13B, 13D, and 13E). Optionally, the upper panel flap's outboard magnet 126 may be magnetically coupled to the side panel flap's magnet 134, which is already magnetically coupled to the side jamb 140a. During the procedure of moving upper panel flap's outboard magnet 126 outboard and into magnetic contact with the side jamb 140a, a user may wish to tuck some of the fabric material of upper panel flap 122 around the inboard and bottom surfaces of the ramp support cable 146 as shown in FIG. 13C. This contributes to enveloping the ramp support cable's upper end portion 146a with fabrics including those of upper panel flap 122 and the corresponding side panel flap 132, as well as nearby end portions 120a, 130a of the upper panel 120 and side panel 130.

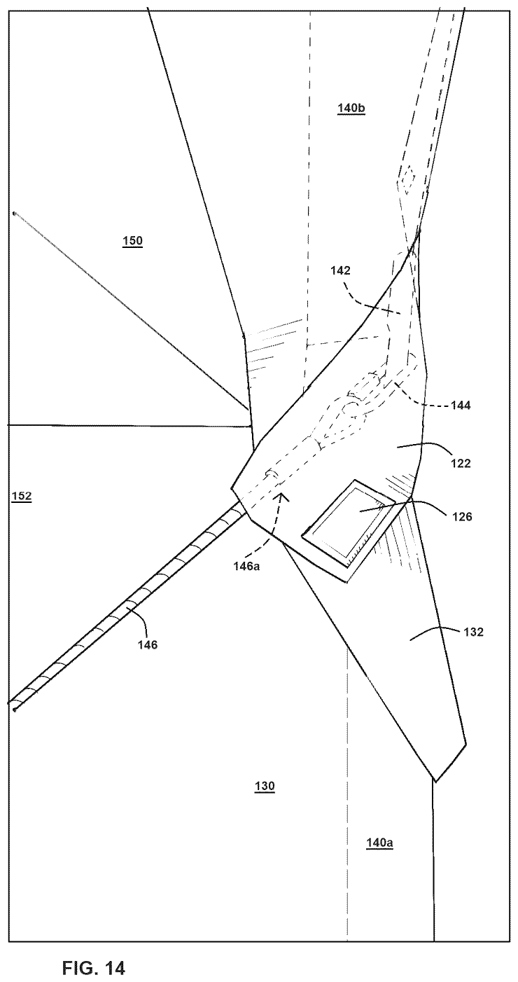

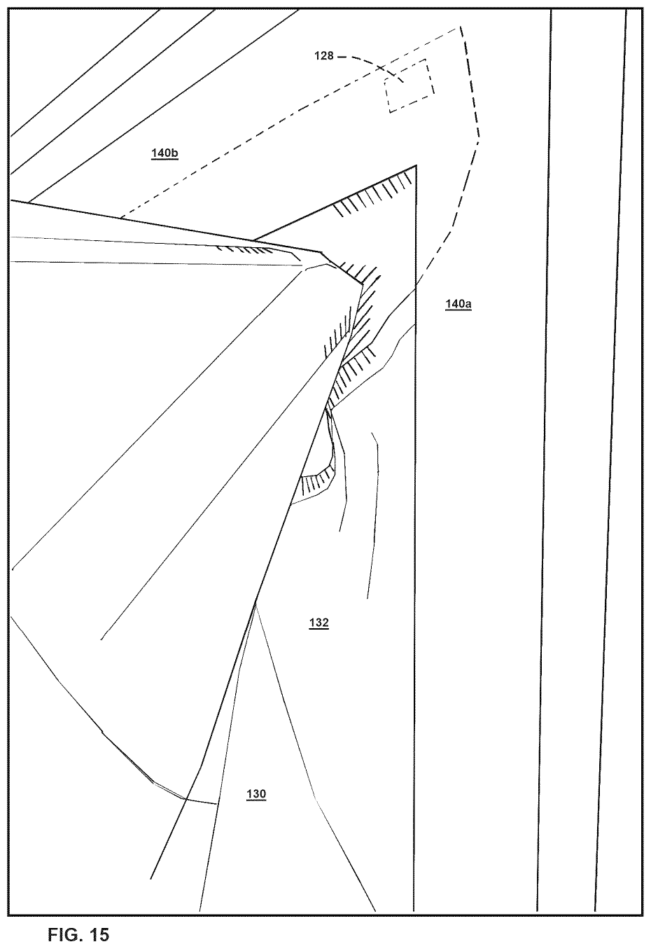

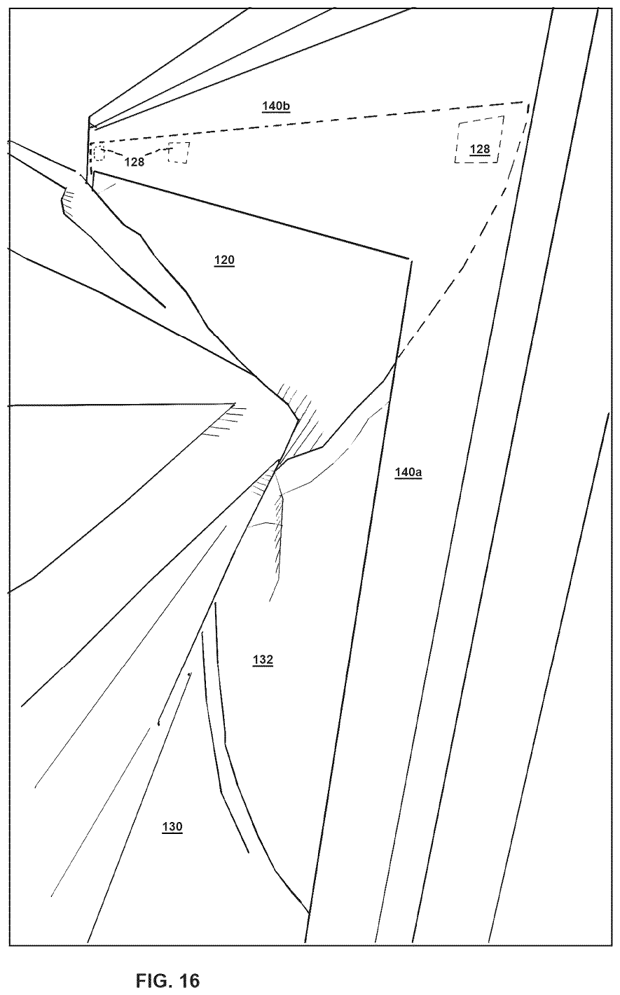

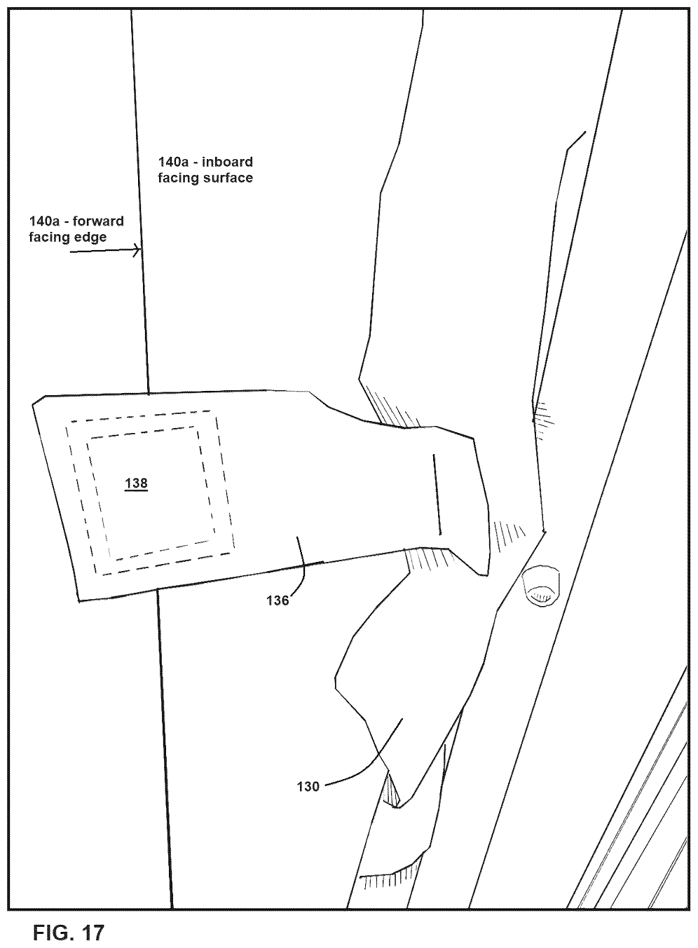

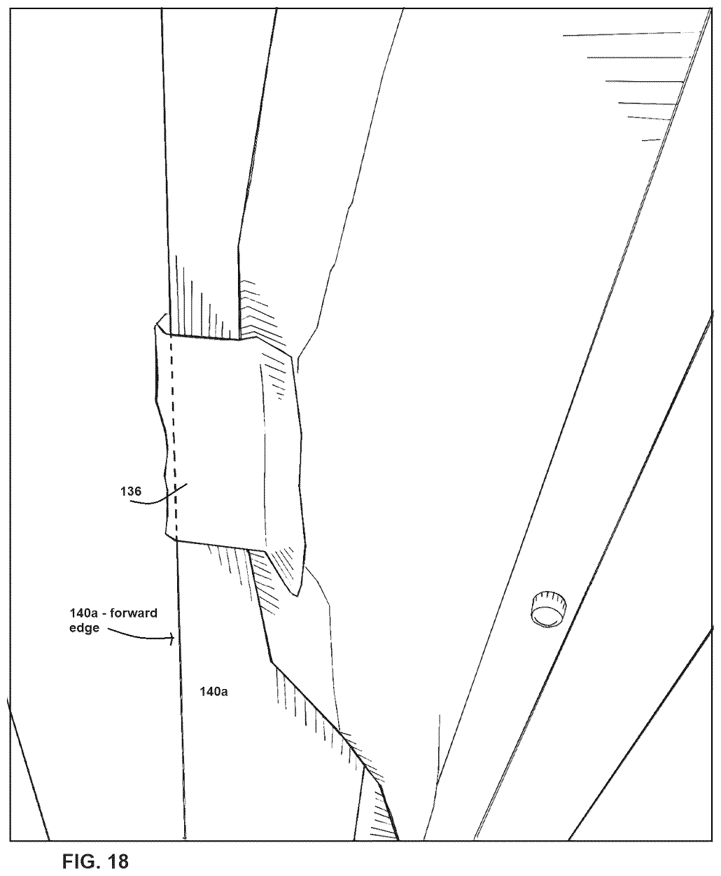

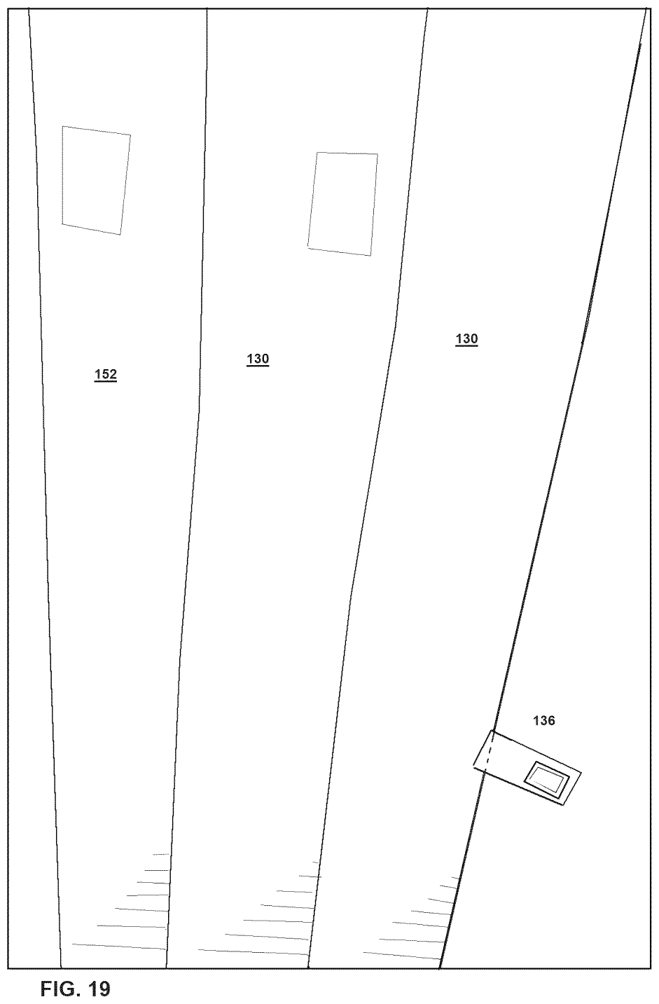

Next, the upper panel flap's inboard magnet 124 is moved laterally outboard and upward diagonally toward the corner brace 142 (or other magnetically permeable structure associated with or located near the frame 140) so that inboard magnet 124 can be attached to an inner or forward-facing surface of corner brace 142, such as shown sequentially in FIGS. 13F-13J. As a final step, the fabrics of upper panel flap 122 and side panel flap 132 may be tucked around the upper end portion 146a of ramp support cable 146, and around the forward-facing surfaces of side jamb 140a and corner brace 142 as shown in FIGS. 13K, 13L, and 14. In this manner, any gaps between the forward end of screen room 100 and the rear end of RV 110, including gaps surrounding cables 146, are spanned and/or enveloped by fabrics of upper panel 120, upper panel tabs 122, side panels 130, and side panel tabs 132. Outer views of the upper right front corner region where screen room 100 secures to the upper right corner of frame 140, after positioning of the upper panel flap 122 and side panel flap 132 as described above, are shown in FIGS. 15 and 16. To further ensure a reasonably taut fit of screen room 100 to the rear end of RV 110, inboard-extending tabs 136 of side panels 130 are pulled forwardly along the inboard-facing surfaces of side jambs 140a so that their associated magnets 138 can be attached along those inboard-facing surfaces, or so that they can be pulled further forward and wrapped around a forward-facing edge of the side jamb 140a and the magnets 138 attached to an outboard-facing surface of the side jamb 140a (FIG. 18). As shown in FIG. 19, a sufficient amount of fabric width may be provided, such as in roughly 4-inch increments, to accommodate different sizes of loading ramps 112 and correspondingly-shaped ramp frames 140.

Optionally, screen room 100 may be structurally erected with framework 160 and panels 120, 130, 150, 152, 154 in their final positions relative to one another, at a location spaced apart from the loading ramp 112, such as along a ground surface near the loading ramp 112. The erected screen room 100 is sufficiently light to be lifted by one or two people and placed atop the perimeter edges of the loading ramp 112, such as outboard of a safety railing 170 that can be mounted to the loading ramp (FIGS. 5 and 6). The safety railing 170 may provide initial support for the screen room 100, such as to prevent it from being blown off of the loading ramp 112 by wind, until the screen room 100 can be secured to ramp 112 and RV 110 as described above. Once erected, screen room 100 provides weather protection and insect protection for occupants supported on loading ramp 112 and inside RV 110, while permitting airflow through any screen mesh panels provided. To remove and disassemble screen room 100, it is a simple matter to release the magnets 124, 126, 128, 134, 138 by gently pulling on the associated fabric until they drop away from the ferrous metal surfaces to which they were secured. It will be appreciated that the various panels and flaps are shaped, and the associated magnets are placed, in such a way that once a given magnet is detached from its installed configuration, it will tend to hang away from ferrous surfaces of the RV so as not to inadvertently reattach during removal of the screen room. Once the magnets are detached, screen room 100 may be lifted upwardly and away from loading ramp 112 and its framework 160 collapsed so that it can be readily stowed in a compact and collapsed configuration.

Accordingly, the screen room provides a convenient structure for providing weather and insect protection for persons who wish to use an extended loading ramp or similar structure as an outdoor patio. No tools are required for set-up or take-down of the screen room, which is structurally similar to common camping tents or certain types of outdoor shelters, and which has a forward panel and arrangement of magnets that facilitate rapid attachment to an RV at the opening where the loading ramp is secured. The use of magnets allows the various fabric pieces to be adjusted and held sufficiently taut against the RV surfaces, while allowing fabric panels to be wrapped around cables and other structures that could otherwise provide ingress paths for insects.

Changes and modifications in the specifically-described embodiments may be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. A screen room for a recreational vehicle (RV) or structure wall, said screen room comprising:
an upper panel having opposing ends and configured to extend laterally across a forward-upper region of the screen room;
an upper panel flap at each opposing end of said upper panel;
first and second releasable upper panel flap couplers in spaced-apart arrangement along each of said upper panel flaps; and
left and right side panels extending downwardly from the respective opposing ends of said upper panel, each of said side panels having an upper portion comprising a side panel flap;
a side panel flap coupler disposed along each of said side panel flaps;
wherein said upper portions of said side panels are coupled to said opposing ends of said upper panel;
wherein said side panel flap couplers are releasably securable to a frame that defines portions of a ramp opening of the RV or structure wall;
wherein said first upper panel flap couplers are releasably securable to the frame, proximate side panel flap couplers, with respective ramp support cables of the RV or structure wall received between said upper panel flaps and corresponding ones of said side panel flaps;
wherein said second upper panel flap couplers are configured to extend laterally inboard and forwardly of the support cables, and are releasably securable to the frame;
wherein said upper panel flaps are configured to extend across respective upper corner gaps defined between said upper panel and the frame; and
wherein said side panel flaps are configured to extend across respective side gaps defined between said side panels and the frame.

2. The screen room of claim 1, wherein said upper panel flaps extend diagonally downwardly, in laterally outboard directions, from a lateral axis of said upper panel.

3. The screen room of claim 2, wherein said side panels each have a vertical axis extending downwardly from said opposing ends of said upper panel, and each of said side panel flaps extending diagonally inboard from said vertical axes and in upward directions.

4. The screen room of claim 1, wherein said upper panel is permanently coupled to said side panels only at upper corner regions thereof, which upper corner regions are outboard of respective base edges of said upper panel flaps and said upper panel flaps when in an uninstalled flat-plan configuration.

5. The screen room of claim 1, wherein said side panels each comprise a plurality of forwardly-extending coupler tabs with releasable tab-couplers, wherein said forwardly-extending coupler tabs are in a vertically spaced arrangement and configured for releasably securing forward edge portions of said side panels to respective upright side jambs of the RV or structure wall.

6. The screen room of claim 5, wherein said upper panel comprise an upper panel coupler disposed between said opposing ends, said upper panel coupler configured for coupling to a header of the frame and thereby retain a central region of said upper panel across an upper central gap between the upper corner gaps.

7. The screen room of claim 1, wherein said couplers comprise magnets.

8. A screen room for a recreational vehicle (RV) or structure wall, said screen room comprising:
a forward upper panel extending across a width of said screen room and comprising:
opposite left and right side regions;
an upper corner region at each of said left and right side regions; and
an upper panel flap at each of said left and right side regions, said upper panel flaps positioned inboard of respective ones of said upper corner regions and each comprising first and second couplers in spaced-apart arrangement;
left and right forward side panels extending along a height of said screen room and extending downwardly from respective ones of said left and right side regions of said forward upper panel, each of said left and right side panels comprising:
an upper corner region; and
a side panel flap positioned inboard of said upper corner region of said side panel, each side panel flap comprising a third coupler in a middle region thereof;
wherein said upper corner region of said left side panel is coupled to said upper corner region at said left side region of said upper panel, and said upper corner region of said right side panel is coupled to said upper corner region at said right side region of said upper panel;
wherein in an uninstalled flat-plan configuration said side panel flaps overlap respective ones of said left and right side regions of said upper panel, and said upper panel flaps overlap said upper regions of respective ones of said side panels; and
wherein said third couplers are configured for releasable securement to a frame of the RV or structure wall, said first couplers are configured to extend laterally outboard and forward of an upper portion of a ramp support cable for releasable securement to the frame of the RV or structure wall, and said second couplers are configured to extend laterally inboard and forward of the upper portion of the ramp support cable for releasable securement to the frame of the RV or structure wall, and with the ramp support cable disposed between the respective side panel flaps and upper panel flaps when said screen room is in an installed configuration.

9. The screen room of claim 8, wherein said upper panel is permanently coupled to said side panels only at said upper corner regions thereof, which are outboard of said upper panel flaps and said upper panel flaps when in the uninstalled flat-plan configuration.

10. The screen room of claim 8, wherein said side panels each comprise a plurality of forwardly-extending coupler tabs with releasable tab-couplers, wherein said forwardly-extending coupler tabs are in a vertically spaced arrangement and configured for releasably securing forward edge portions of said side panels to respective upright side jambs of the RV or structure wall.

11. The screen room of claim 8, wherein said first, second, and third couplers comprise magnets disposed inside fabric pouches.

12. The screen room of claim 8, wherein said upper corner regions comprise respective diagonal edges of said upper panel and of said side panels, wherein said diagonal edges extend both upwardly and laterally outboard of said upper panel flaps and said side panel flaps when in the uninstalled flat-plan configuration.

13. The screen room of claim 12, wherein said diagonal edges of said upper panel are sewn to respective ones of said diagonal edges of said side panels.

14. The screen room of claim 8, wherein said upper panel tabs extend diagonally downwardly and laterally outboard of said upper corner regions, and said side panel tabs extend diagonally upwardly and laterally inboard of said upper corner regions.

15. The screen room of claim 8, further comprising:
a roof panel coupled to and extending rearwardly from a rearward edge of said upper panel;
left and right lateral side panels coupled to and extending rearwardly from respective rearward edges of said left and right forward side panels; and
a back panel having an upper edge coupled to and extending downwardly from a rearward edge of said roof panel, said back panel having left and right side edges coupled to and extending inboard from respective rear edges of said left and right lateral side panels.

16. The screen room of claim 15, wherein said left and right lateral side panels and said back panel comprise respective lower portions configured to extend downwardly below and/or outboard of respective lateral sides and a rearward end of a ramp of the RV or structure wall when the ramp is in an open and substantially horizontal configuration.

17. The screen room of claim 8, wherein said forward upper panel and said left and right forward side panels comprise separate fabric panels that are sewn together.

18. A method of installing a screen room at an extendable ramp of a recreational vehicle (RV) or a structure wall, said method comprising:
positioning a screen room atop the extendable ramp, the screen room having a forward upper panel and a pair of forward side panels extending downwardly from opposite ends of the forward upper panel;
positioning respective side panel flaps along a frame of the RV or structure wall, the side panel flaps passing forwardly and laterally outboard of a support cable associated with the extendable ramp;
releasably securing the side panel flaps to the frame with respective side panel flap couplers;
positioning respective first portions of a pair of upper panel flaps at the opposite ends of the forward upper panel, to pass laterally inboard of the support cables and then to extend laterally outboard and forward the support cables, wherein respective ramp support cables are disposed between the side panel flaps and the first portions of the upper panel flaps;
releasably securing a first upper flap coupler, located at the first portion of each of the upper panel flaps, to the frame of the RV or structure wall;
positioning respective second portions of the pair of upper panel flaps to extend laterally inboard and forward of the ramp support cable; and
releasably securing a second upper flap coupler, located at the second portion of each of the upper panel flaps, to the frame of the RV or structure wall.

19. The method of claim 18, wherein said releasably securing the side panel flaps to the frame comprises attaching the side panel flap couplers to respective upright side jambs of the frame.

20. The method of claim 19, wherein said releasably securing the first upper flap couplers comprises attaching the first upper flap couplers to the respective upright side jambs of the frame, proximate the side panel flap couplers.

21. The method of claim 20, wherein said releasably securing the second upper flap couplers comprises attaching the second upper flap couplers to a header of the frame, above the first upper flap couplers and the side panel flap couplers.

22. The method of claim 18, wherein the side panel flap couplers and the first and second upper flap couplers comprise magnets.
